(19) United States
(12) Patent Application Publication
(10) Pub. No.: US 2010/0162590 A1
(43) Pub. Date: Jul. 1, 2010

(54) Friction Enhancing Device

(76) Inventor: Burkhard Bönigk, Konigsbrunn (DE)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/523,821

(22) PCT Filed: Nov. 23, 2007
(86) PCT No.: PCT/NO07/00415

§ 371 Date: Mar. 9, 2010

(30) Foreign Application Priority Data
Jan. 18, 2007 (NO) 20070333

(51) Int. Cl. A43B 13/00; D04H 13/00; B32B 27/12; B32B 25/10; B32B 3/00; A43B 3/16; A43B 21/00

(52) U.S. Cl. 36/103; 442/414; 442/395; 442/394; 442/399; 428/172; 442/337; 36/7.1 R; 36/105

(57) ABSTRACT

A sole (1) for a pedestrian's shoe or a slipover device (18) for such a shoe has a base consisting of a non-woven microfibre material made of thermoplastic polyester PVC knobs or polyamide. The microfibre material is exposed in an arcuate section (5) in the front foot portion (2), in the mid-foot portion (3) and in a wheel-shaped section (6) in the heel portion (4) of the sole. An elastomer material is deposited as rounded knobs onto the microfibre material in a fore portion (7) of the front foot portion (2) and in a ring (8) and sectors (9) in the heel portion (4) of the sole (1). A PVC material is deposited, also in the form of rounded knobs, in a transverse band (10) in the front foot portion (2) and in a larger part (11) of the heel portion (4) so as to surround the ring (8). The use of the microfibre material as a means of enhancing friction on an icy surface is also disclosed.

The present invention relates in the broadest sense to a device for enhancing friction between a movable object and a smooth or slippery surface.

The present invention came to light in the search for a device that could be used with a pedestrian's shoe to improve friction on a slippery surface, primarily covered by ice or snow. Traditionally, such devices have included a carrier to be attached to the underside of a pedestrian's shoe by means of straps or the like, the carrier having spikes or cleats depending therefrom for engagement with the slippery surface. Examples of such devices are described in U.S. Pat. No. 5,315,768 and U.S. Pat. No. 5,485,687. Such devices may work well on packed snow and ice, but they cannot be worn indoors since the spikes will mar carpets and wooden floor surfaces. On hard surfaces like ceramic tile and polished rock material, the spikes may skid and cause a perilous situation for the wearer.

To avoid these indoor problems, early attempts have been made to make anti-skid devices based on fabric or cloth material. Thus, U.S. Pat. No. 2,258,322 discloses a generally tubular device made from cloth and elastic bands, said device being slipped onto the front part of the wearer's shoe and being held in place by a strap running around the heel portion of the shoe. The downwardly facing surface of the device is said to be rugose in order to provide friction on an icy surface.

U.S. Pat. No. 2,408,152 discloses an anti-skid device made from canvas and made to fit either the sole or heel portion of the shoe. One side of the device is provided with an adhesive to facilitate application to the shoe. Spaced along its periphery the device is provided with tabs, equally provided with an adhesive, to be bent up from the bottom of the shoe and attached to the upper leather of the shoe. In this device, the coarseness of the canvas is supposed to prevent the wearer from slipping on wet or icy surfaces.

In the 60 or so years since their conception, these devices have not gained any wide acceptance, and devices having metal spikes or cleats are still by far the most prevalent type.

A more recent suggestion for a footwear fraction device without spikes or the like that could damage indoor floors and carpets is known from U.S. Pat. No. 5,943,792. The device comprises a pad to be strapped to the sole of the wearer's shoe. The pad is made from a hygroscopic woven material tending to absorb water such as cotton, wool or other natural fibres. The water laden fibres are supposed to instantaneously freeze when brought into contact with the ice or snow with each step of the wearer to produce frictional contact. The pad is also provided with an interrupted, transversely disposed ribbed pattern to provide some mechanical resistance to slippage when the atmospheric conditions are not conducive to the purported freezing effect.

Common to most of the prior art anti-skid devices for footwear is that they are uncomfortable to wear since they protrude from the sole of the shoe and break up the smooth step of the wearer and cause an unnatural walking pattern.

Thus, one object of the present invention is to provide an improved friction enhancing device of the type mentioned above which is practicable and versatile and which preferably may be worn indoors to improve friction on wet and hard floors, yet without harming the floors.

A second object of the invention is to provide a device for enhancing friction between a movable object and a smooth or slippery surface.

A further object is to provide a material that may be used to realise the objects mentioned above.

These and other objects may be attained by devices and uses as defined in the appended claims.

The invention will be described in more detail with reference to the exemplifying embodiments shown schematically in the appended drawings, where:

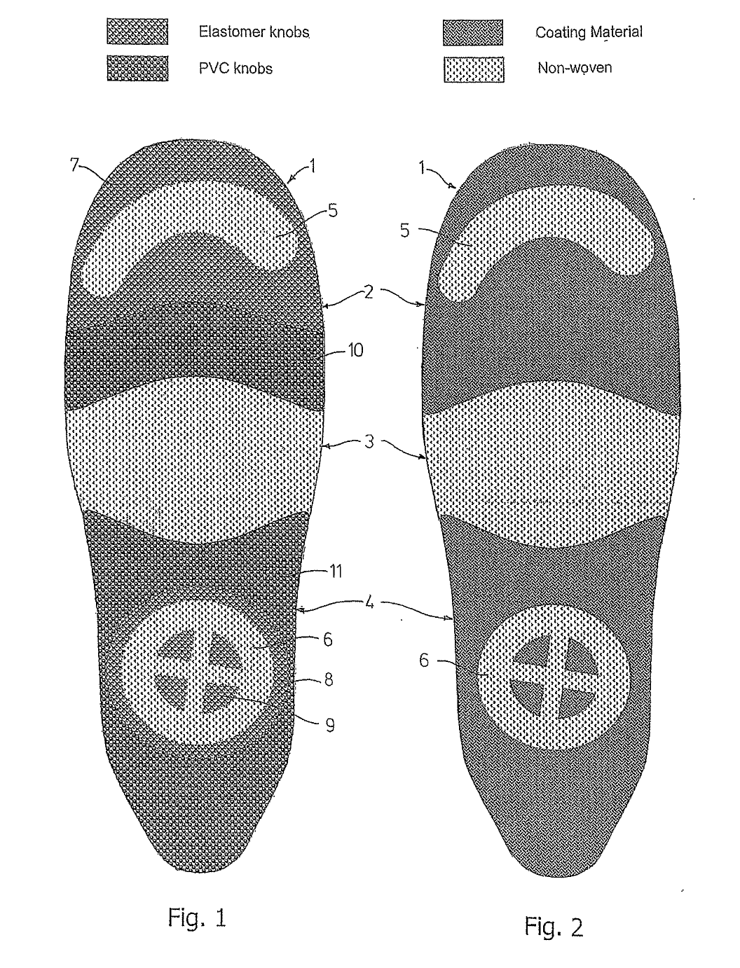

FIG. 1 is a plan view of a sole for a shoe or a slipover device for same according to a first embodiment of the present invention;

FIG. 2 is a view similar to FIG. 1 of a second embodiment of the invention;

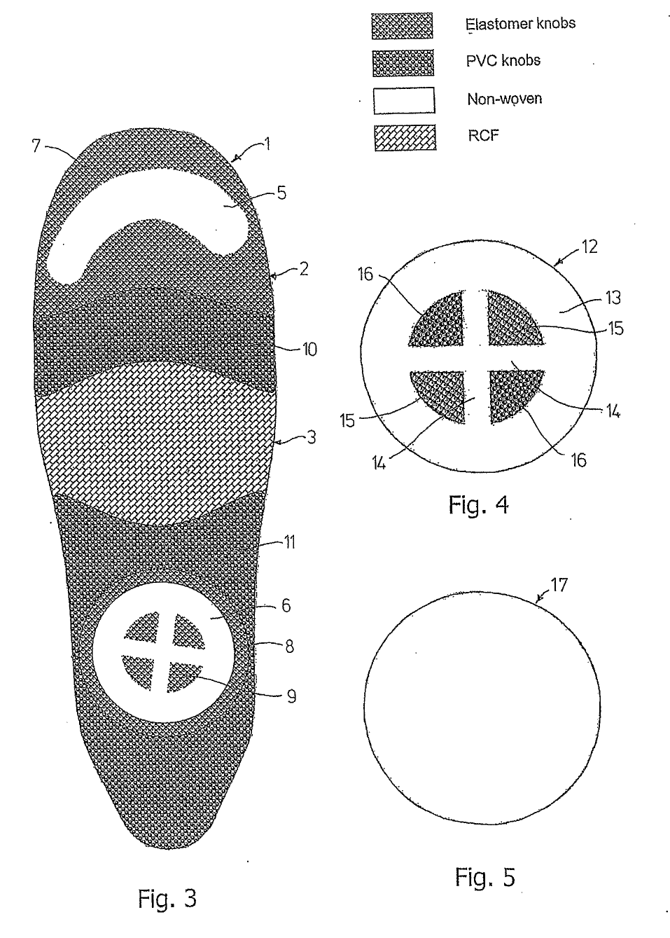

FIG. 3 is a view similar to FIG. 1 of a third embodiment of the present invention;

FIG. 4 shows a plan view of a fourth embodiment according to the present invention of a pad to be attached to an object to increase the friction between the object and a smooth or slippery surface; and

FIG. 5 is a view similar to FIG. 4 of a pad according to a fifth embodiment of the to present invention.

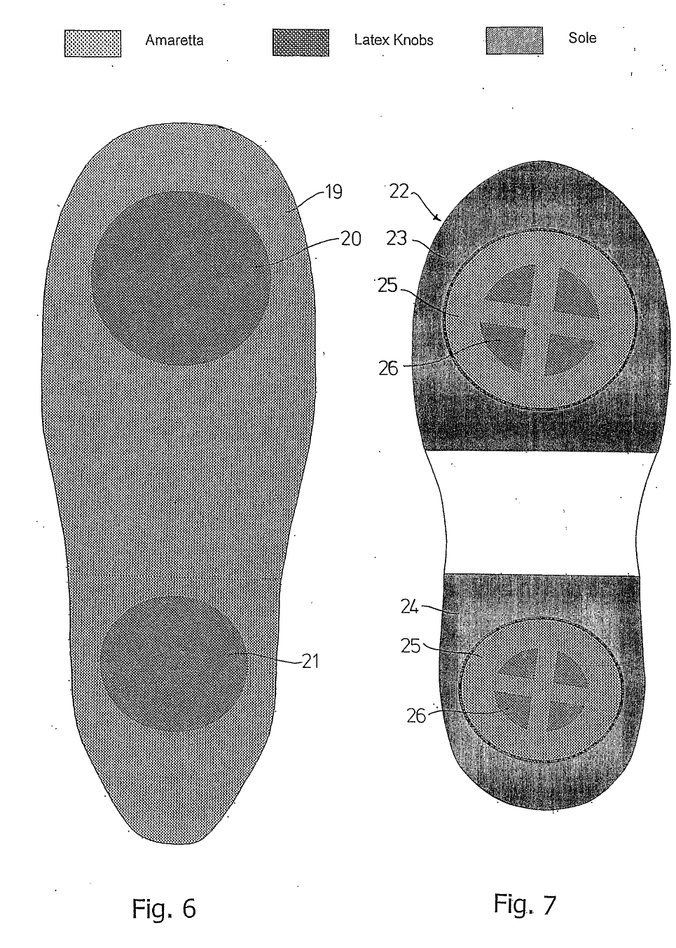

FIG. 6 is a view similar to FIG. 1 of a sixth embodiment of the present invention.

FIG. 7 is a plan view of a sole of a shoe incorporating a seventh embodiment of the present invention.

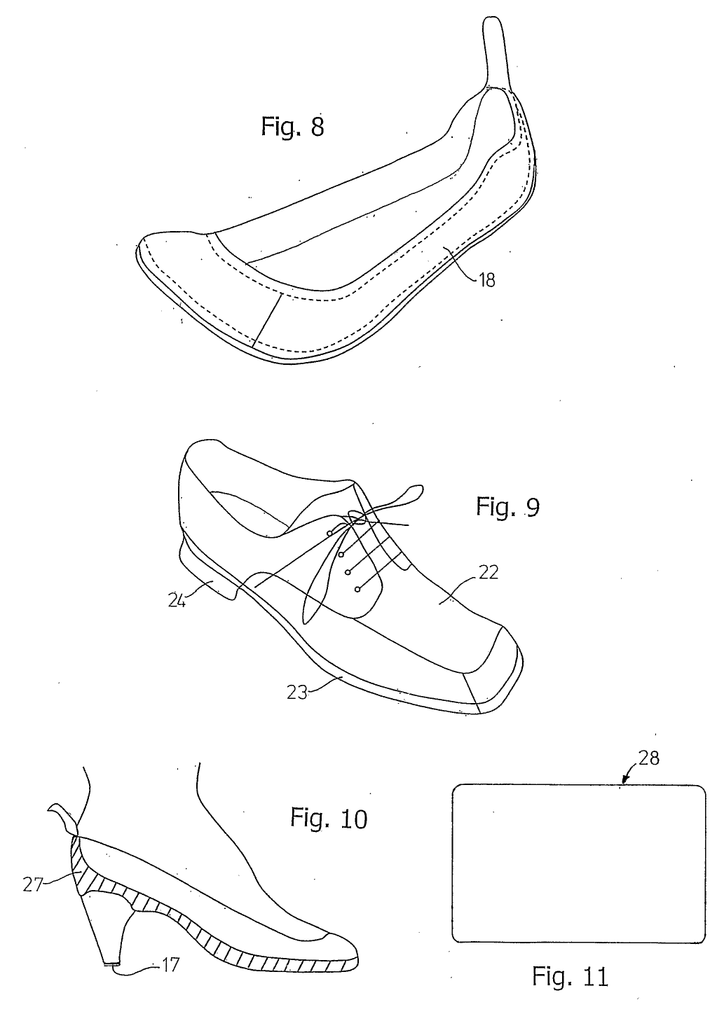

FIG. 8 is a perspective view of a slipover device suitable for use with the present invention.

FIG. 9 is a perspective view of a shoe suitable for use with the present invention.

FIG. 10 is a side view of a shoe illustrating an eighth embodiment of the present invention.

The soles 1 shown in FIGS. 1, 2 and 3 all have a front foot portion 2, a mid foot portion 3, and a heel portion 4.

Referring to FIG. 1, the sole 1 has a substrate material which covers the entire sole and is constituted by a non-woven microfibre material, preferably made of a thermo-plastic polyester or polyamide. Suitable examples of such materials are the polyamide microfibre material Amaretta® made by the Japanese firm Kuraray and the polyester microfibre material Evolon® made by the German firm Freudenberg. In the front foot portion 2, the microfibre material is exposed in an arcuate fore section 5. Furthermore, the micro fibre material is exposed in most of the mid-foot portion 3 and in a generally wheel-shaped section 6 of the heel portion 4.

In the front foot portion 2, the arcuate fore section 5 of the exposed microfibre material is surrounded by a portion 7 comprising an elastomer material, preferably deposited on the microfibre material in the form of discrete protrusions having a rounded form and being placed in a regular pattern. Similar elastomer protrusions are deposited in a ring 8 around the wheel-shaped section 6 of the heel portion 4 and in the sectors 9 delimited by the rim and spokes of the wheel 6.

Between the forward portion 7 of the front foot portion 2 and the mid-foot portion 3, the base non-woven microfibre material of the sole 1 is provided with a transverse band 10 comprising a PVC material deposited on the base material in the form of protrusions preferably having a rounded form. Similarly, the part 11 of the heel portion 4 not occupied by the wheel-shaped section 6 and ring 8 is also covered by the protrusions of PVC material.

The applicant has performed a large number of experiments on a variety of materials in order to test their frictional properties on the various surfaces encountered by a pedestrian both outdoors and indoors during the winter season. In addition, the tests have included some applications like wet and dry decks of boats made from polyurethane, epoxy, acrylics or the like. These experiments showed that one material alone could not fulfill the target of providing sufficient friction and wear resistance on all the surfaces tested under the varying environmental conditions, but that a combination of materials had to be used for most of the cases.

Nevertheless, the test showed very surprisingly that the non-woven microfibre material, preferably made of thermoplastic polyester or polyamide, exhibited very good frictional properties on ice and performed well also under other, quite different environmental conditions. As an example, the material would be suitable for use as underlay to keep rugs and carpets steadily in place when trodden upon. Furthermore, non-woven microfibre materials may be made with such a high strength and wear resistance that they can advantageously replace other sole materials formerly expected to have superior properties in these respects. The microfibres should preferably have a fineness of less than 2 dtex, preferably less than 1 dtex, and have a non-circular cross-section, either multi-lobal or polygonal, preferably a triangular cross-section.

The elastomer material used in the sole 1 according to FIG. 1, which material may be a latex rubber, adds to the friction properties on ice and is also useful e.g. on wet and dry polymer, wood, metal and stone surfaces. The PVC material is useful on hard surface and also on snow, partly due to the uneven surface caused by the pattern of protrusions.

It will be understood that footwear having a sole design according to FIG. 1, whether in the form of a shoe or a slipover device for a shoe, for instance like a low sock 18 as shown in FIG. 8 or a galosh, can be worn at an advantage outdoors on ice and snow, as well as indoors on common floor surfaces, whether wet or dry. Thus, the wearer can walk from a wintry street into a store without having to change the footwear or having any fear of skidding on a hard and wet floor. Furthermore, the wearer does not have to worry about marring the floor, since his footwear is entirely without metal spikes or hard particles, but is instead made of relatively soft and pliant materials.

The embodiment of the sole 1 shown in FIG. 2 is a simplification of the FIG. 1 embodiment and is intended for use where ice and snow are the prevalent environmental conditions. The base material of the sole is also here a man-made microfibre non-woven material, while the elastomer and PVC materials have been replaced by a rubber coating, preferably having a pattern of ridges to enhance the gripping ability on snow.

The embodiment in FIG. 3 also looks much like the one in FIG. 1. However, the base material of the sole 1 is here what is labelled RCF, which is an acronym for Road Contact Fabric and is the material currently used in the traction aid for automobiles marketed by the applicant under the trade name AutoSock®. Like in the FIG. 1 embodiment, the elastomer and PVC protrusions are applied directly to the base material, but the arcuate fore section 5 and wheel shaped heel section 6 are cutouts of non-woven microfibre material which are glued in place on the base RCF material of the sole 1. In the mid-foot portion 3 the RCF is exposed. This material has been developed to give good friction properties both on snow and ice, and the FIG. 3 embodiment may therefore be somewhat superior to the FIG. 1 embodiment when there is more snow than ice. The RCF may be a polymer textile material, preferably a polyester or polyamide textile material, a multilayer polymer textile material with layers interconnected by a common yarn system, by gluing, or by welding. Further details may be found in the applicant's EP 1165329 B9.

It will be understood that in order to prevent water from soaking through the sole 1 when used in a wet environment, the sole material may be provided on the reverse side with a waterproof coating of a suitable material, e.g. an elastomer material.

Furthermore, it will be understood that if the sole 1 is part of a slipover device for the wearer's shoe, the slipover device may be made reversible so that both sides of the sole may be used alternately as the contact surface with the ground. In this way, one side of the sole may be optimised for one set of circumstances, while the reverse side is optimised for another set of circumstances. For example, one side may be optimised for snow, while the reverse side is optimised for ice. In such a case, if the slipover device is not or only seldom is used indoors, the side for use on ice may be provided with one or more sections having a layer of hard or abrasive particles. It will also be understood that one side of the sole may be optimised for outdoor and the other one for indoor use.

Even though a slipover device with a sole according to one of the embodiments in FIGS. 1-3 may be folded into rather small packages, a person may still not wish to carry it along on a regular basis if the need for such a friction enhancing device is infrequent or sporadic. The invention therefore also provides a friction enhancing device which is small enough to be carried in a woman's purse or a man's wallet or breast pocket and still provide a measure of added security in situations where a quick and easy solution to an unexpected or temporary situation is desired. For this purpose, the present invention provides a self-adhesive patch of friction enhancing material as shown schematically in FIG. 4. The patch 12 has the general shape of a wheel with a rim 13 and spokes 14 made from synthetic non-woven microfibre material, while two opposite sectors 15 delimited by the rim 13 and spokes 14 are provided with knob-like protrusions of an elastomer material. The other two opposite sectors 16 are provided with knob-like protrusions of a PVC material.

The reverse side of the patch 12 is provided with an adhesive, which prior to use is covered by a protective paper or the like that can be peeled off to expose the glue, whereupon the patch may be attached to the sole of the shoe of the user. The glue used may be one that will also stick to slightly wet surfaces, for instance of the type that is used for ski furs. In most cases, the user will put a patch under the front part of the sole, but he may of course also put one under the heel in order to further improve his sure-footedness.

FIG. 5 shows schematically a patch made entirely from non-woven microfibre material. It may be used as an undershoe device to provide increased friction on ice, for instance where the sole of the shoe has a pattern and material giving good traction on snow, and will also improve friction indoors on wet or slippery floors. Furthermore, the patch according to FIG. 5 may be used under rugs and carpets to keep them in place on the floor.

FIG. 6 shows a simplification of the FIG. 2 embodiment and is designed for minimizing manufacturing costs while maintaining considerable friction enhancing properties. The sole 19 is made from a man-made microfibre material, preferably polyamide material, and is provided with front foot and heel patches 20 and 21, respectively, of knobs of an elastomer material, preferably a latex rubber.

FIG. 7 shows a view from underneath of a shoe, e.g. of the type schematically illustrated in FIG. 9. Basically, the shoe 22 has a regular front sole portion 23 and heel portion 24. The portions 23 and 24 are each provided with a somewhat wheel-shaped patch 25 of a man-made microfibre material, preferably a polyamide material, the sectors 26 between the “spokes” and “rim” of the wheel being covered by protrusions or knobs of an elastomer material, preferably a latex rubber. The patches 25 are permanently or semi-permanently embedded into the respective sole and heel portions 23, 24. Thus, the patches may be molded or fused into the shoe material during the manufacturing process of the shoe. Alternatively, the sole and heel portions may have shallow recesses wherein the patches 25 are attached by means of a strong glue which, nevertheless, will permit replacement of the patches if worn out prematurely.

As yet another example of the versatility of the present invention, FIG. 10 shows schematically a slipover device 27 for high-heeled women's shoes. If the heel is not too slender, it may be provided at the end with a patch 17 as shown in FIG. 5 cut to the appropriate size.

FIG. 11 shows a patch 28 for the same purpose as the patches 12 and 17 shown in FIGS. 4 and 5, respectively, The patch 28 has the general shape of a standard credit card and may also have the same dimensions 21/8×33/8 inches (54×86 mm). Thus, it will fit within the credit card organiser many people carry in their purse or wallet. The patch 28 may also be somewhat smaller than a credit card, say, 49×80 mm, in order to fit within a protective envelope (not shown) having the credit card dimensions and preferably being made of a transparent plastics material.

It will be understood that the embodiments of the invention described above are to be regarded as examples only and are not meant to limit in any way the scope of protection provided by the appended claims. For instance, in order to reduce production costs even further, the embodiment shown in FIG. 6 may be modified by letting the entire sole 19 be cut from a sheet of microfibre material which is covered uniformly by elastomere knobs, PVC knobs, or both. If both elastomere and PVC knobs are used, they may be arranged in mutually staggered rows.

1. A sheet-like device for enhancing friction between a moveable object and a smooth or slippery surface, characterized in that the device comprises a man-made, non-woven microfibre material, preferably made of thermoplastic polyester or polyamide.

2. A device according to claim 1, wherein said non-woven material is joined to a substrate material.

3. A device according to claim 1, wherein said non-woven material forms a substrate material for at least one further material.

4. A device according claim 2, wherein said substrate material is chosen from the group comprising a polyester textile material, a polyamide textile material, a multilayer polymer textile material with layers interconnected by a common yarn system, by gluing, or by welding, and any one of these materials with an elastomer coating on one side.

5. A device according to claim 2, wherein said substrate material comprises at least one portion coated with an elastomer material, preferably natural or synthetic rubber.

6. A device according to claim 5, wherein said elastomer material has the form of protrusions.

7. A device according to claim 2, wherein said substrate material comprises protrusions of a PVC soft composite material.

8. A device according to claim 5, wherein said substrate material is shaped substantially like the sole of a pedestrian's shoe and has a front foot portion, a mid foot portion and a heel portion; at least the front and heel portions having said non-woven material and at least one of said elastomer and PVC materials.

9. A device according to claim 8, wherein said front foot portion has a fore section provided with an elongate transversely extending part made of said non-woven material and being surrounded by said elastomer material, and a rear section provided with said PVC material.

10. A device according to claim 8, wherein in said heel portion a patch of said non-woven material is surrounded by a ring of said elastomer material, the remainder of the heel portion being provided with said PVC material.

11. A device according to claim 9, wherein said patch has parts provided with at least one of said elastomer and PVC materials.

12. A device according to claim 8, wherein said substrate material is exposed in said mid foot portion.

13. A device according to claim 1, wherein one side of the device is provided with a self-adhesive substance.

14. A device according to claim 13, shaped like a patch for application as a glide protection to the sole of a pedestrian's shoe or to the underside of a floor rug or carpet.

15. A device according to claim 5, wherein said protrusions are placed in a regular pattern and preferably have a rounded form.

16. A device according to claim 1, wherein the microfibre material comprises fibers that have polygonal cross-sections and have an average fineness of less than 2 dtex, preferably less than 1 dtex.

17. A slipover device for a pedestrian's shoe having a sole material claim 1.

18. A slipover device according to claim 17, wherein the device is reversible and has a sole with friction enhancing material on both sides.

19. A pedestrian's shoe into the sole and preferably also the heel (24) of which a device according to claim 5, shaped like a patch (25), is at least semi-permanently embedded.

20. The use of a non-woven man-made microfibre material to be interposed between two surfaces to enhance friction between them.

21. The use according to claim 20, wherein one of said surfaces is covered at least partially by ice.
